(19) United States
(12) Patent Application Publication
(10) Pub. No.: US 2025/0023949 A1
(43) Pub. Date: Jan. 16, 2025

(54) ONBOARD MACHINE AND VEHICLE INFORMATION MANAGEMENT SYSTEM

(71) Applicant: Niterra Co., Ltd., Nagoya-shi, Aichi (JP)

(72) Inventors: Sei KAWAMOTO, Nagoya-shi (JP); Tatsuo SASAKI, Nagoya-shi (JP); Akio NISHIKAWA, Nagoya-shi (JP); Takanori HORIGUCHI, Nagoya-shi (JP); Ryosuke OCHIAI, Nagoya-shi (JP)

(21) Appl. No.: 18/712,189

(22) PCT Filed: Nov. 22, 2022
(86) PCT No.: PCT/JP2022/043148

§ 371 Date: May 21, 2024

(30) Foreign Application Priority Data
Nov. 25, 2021 (JP) 2021-190993

(51) Int. Cl. H04L 67/125; H04W 4/80; H04W 76/10

(52) U.S. Cl. CPC H04L 67/125; H04W 4/80; H04W 76/10

(57) ABSTRACT

A portable terminal (40) includes an application program (48A). The application program (48A) is activated when the portable terminal (40) has received a beacon signal in a predetermined format including predetermined identification information, and causes the portable terminal (40) to perform an operation of establishing connection by a near field communication method, after activation. A communication unit (23) of an onboard machine (20) alternately repeats one or more times of a first operation of wirelessly transmitting first advertising information in the predetermined format including the identification information, as the beacon signal, and one or more times of a second operation of wirelessly transmitting second advertising information by the near field communication method.

### TECHNICAL FIELD

The present invention relates an onboard machine and a vehicle information management system.

### BACKGROUND ART

Patent Document 1 discloses an example of an onboard machine provided in a vehicle. The onboard machine disclosed in Patent Document 1 includes a communication unit which performs near field communication with a portable terminal, and a pairing permission unit. When a portable terminal for which the same identifier as an identifier that uniquely identifies the onboard machine is set has entered within a predetermined distance from the onboard machine, the pairing permission unit causes the portable terminal to receive data including the identifier, thereby permitting pairing of the onboard machine and the portable terminal.

### PRIOR ART DOCUMENT

### Patent Document

Patent Document 1: Japanese Patent Application Laid-Open

### SUMMARY OF THE INVENTION

### Problem to be Solved by the Invention

In such an onboard machine that, when an application program is in an activated state on a portable terminal, performs operation coordinated with the application program while performing wireless communication by a near field communication method, the coordinated operation cannot be performed when the application program is in an ended state.

The present invention has been made to solve at least one of the above problems, and an object of the present invention is to provide technology that can start coordinated operation by an action from an onboard machine side when an application program is in an ended state.

### Means for Solving the Problem

An onboard machine according to one aspect of the present invention includes: an acquisition unit configured to acquire vehicle information indicating a state of a vehicle, from the vehicle; and a wireless communication device configured to wirelessly transmit the vehicle information acquired by the acquisition unit, to a portable terminal, by a near field communication method. The portable terminal includes an application program configured to be activated on the portable terminal when the portable terminal has received a beacon signal in a predetermined format including predetermined identification information, and cause the portable terminal to perform an operation of establishing connection by the near field communication method, after activation. The wireless communication device alternately repeats one or more times of a first operation of wirelessly transmitting first advertising information in the predetermined format including the identification information, as the beacon signal, and one or more times of a second operation of wirelessly transmitting second advertising information by the near field communication method.

In a case where the portable terminal having the application program is present in an area where the beacon signal reaches, this onboard machine can activate the application program by the beacon signal. Then, after the beacon signal, the onboard machine can provide the second advertising information to the portable terminal on which the application program is operating, and therefore can establish connection for near field communication between the portable terminal and the onboard machine. Further, even if the portable terminal cannot receive the beacon signal, thereafter transmission of the beacon signal is repeated. Therefore, as long as the portable terminal is present in an area where the beacon signal reaches, the beacon signal is likely to be successfully received by the portable terminal. In addition, since the second advertising information is transmitted after each beacon signal, connection for near field communication is easily established immediately after the beacon signal is successfully received (i.e., after activation of the application program).

The beacon signal may be a signal conforming to a standard of iBeacon (registered trademark). The near field communication method may be a BLE (Bluetooth (registered trademark) Low Energy) method.

In this onboard machine, the application program can be activated by the beacon signal conforming to the standard of iBeacon (registered trademark), so that versatile processing conforming to the standard of iBeacon (registered trademark) can be performed. Then, after the application program is activated, connection for wireless communication by the BLE method can be established, so that versatile processing conforming to the BLE method can be performed.

A vehicle information management system may be formed by including the above onboard machine and the above application program.

The vehicle information management system provides the same effects as those of the above onboard machine.

### Advantageous Effects of the Invention

The present invention makes it possible to start coordinated operation by an action from an onboard machine side when an application program is in an ended state.

### BRIEF DESCRIPTION OF THE DRAWINGS

FIG. 1 is a block diagram conceptually exemplifying the configurations of a vehicle information management system of the first embodiment, and a vehicle and the like to which the vehicle information management system is applied.

FIG. 2 is a diagram schematically and conceptually illustrating an example in which a plurality of portable terminals are used, regarding the vehicle information management system of the first embodiment.

FIG. 3 is a diagram conceptually illustrating a first database.

FIG. 4 is a diagram conceptually illustrating a second database.

FIG. 5 is a diagram illustrating operation of the vehicle information management system of the first embodiment.

FIG. 6 is a diagram conceptually illustrating communication establishment operation performed between an onboard machine and a portable terminal in the vehicle information management system of the first embodiment.

### MODES FOR CARRYING OUT THE INVENTION

### 1. First Embodiment

### 1-1. Configuration of Vehicle Information Management System 100

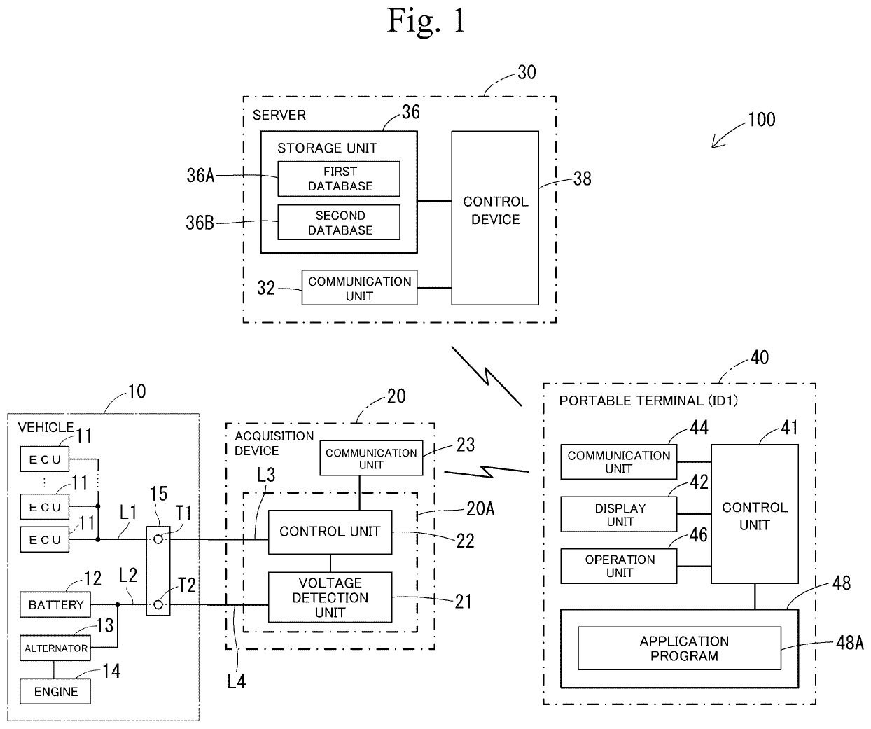

A vehicle information management system 100 shown in FIG. 1 is a system for managing information about a vehicle 10. The vehicle information management system 100 mainly includes an onboard machine 20, a server 30, and an application program 48A included in a portable terminal 40.

The vehicle 10 to which the vehicle information management system 100 is applied is an engine vehicle driven by a gasoline engine, for example. The vehicle 10 mainly includes an electronic control device 11, a battery 12, an alternator 13, an engine 14, a connector 15, a communication line L1, a power line L2, and the like.

The electronic control device 11 is a device for controlling equipment mounted on the vehicle 10. A plurality of the electronic control devices 11 are provided. Each electronic control device 11 is, for example, a known ECU (Electronic Control Unit). In FIG. 1, each electronic control device 11 is denoted as “ECU”. The battery 12 is, for example, a vehicular battery such as a lead battery. The alternator 13 is a known alternator that generates electricity by being driven by the engine 14.

The connector 15 is a connector that can output vehicle information indicating the state of the vehicle 10 in conformity with a communication standard of OBD2 (On Board Diagnosis second generation). The connector 15 includes a first terminal T1 and a second terminal T2. The communication line L1 is electrically connected to the first terminal T1. The communication line L1 is, for example, a CAN (Controller Area Network) communication bus. The communication line L1 is electrically connected to each of the electronic control devices 11. Information that is transmitted/received by each electronic control device 11 flows through the communication line L1.

The power line L2 is electrically connected to the second terminal T2. The power line L2 is connected to each of the battery 12 and the alternator 13. Output voltage of the battery 12 and output voltage of the alternator 13 are applied on the power line L2. In a state where the alternator 13 is not driven, only output voltage of the battery 12, of the battery 12 and the alternator 13, is applied on the power line L2. Output voltage of the battery 12 in a full-charge state is greater than 0 V, and is, for example, 12 V. In a state where the alternator 13 is driven, the higher one of output voltages of the battery 12 and the alternator 13 is applied on the power line L2. In a state where the alternator 13 is driven, voltage applied on the power line L2 is, for example, 14 V at maximum.

The onboard machine 20 is a device that functions as a vehicle information acquisition device. The onboard machine 20 is mounted in the vehicle 10 in a state where the onboard machine 20 is continuously connected to the above connector 15. The onboard machine 20 mainly includes an acquisition unit 20A and a communication unit 23. The acquisition unit 20A has a function of acquiring vehicle information indicating the state of the vehicle 10, from the vehicle 10. The communication unit 23 corresponds to an example of a transmission unit.

The acquisition unit 20A includes a first connection line L3, a second connection line L4, a voltage detection unit 21, and a control unit 22. The acquisition unit 20A is connected to the connector 15 of the vehicle 10 and can acquire vehicle information from the vehicle 10. The acquisition unit 20A has a connector (not shown) including terminals at ends of the first connection line L3 and the second connection line L4, and this connector is attached to the connector 15. Then, the acquisition unit 20A acquires, from the vehicle 10, vehicle information indicating the state of the vehicle 10 by wired communication via the first connection line L3 and the second connection line L4. For example, in a case where the connector (not shown) of the acquisition unit 20A is connected to the connector 15, the first connection line L3 is electrically connected to the first terminal T1 of the connector 15. That is, the first connection line L3 is electrically connected to the communication line L1 via the first terminal T1. As a result, information that is transmitted/received by each electronic control device 11 flows through the first connection line L3.

In addition, in a case where the onboard machine 20 is connected to the connector 15, the second connection line L4 is electrically connected to the second terminal T2 of the connector 15. That is, the second connection line L4 is electrically connected to the power line L2 via the second terminal T2. As a result, voltage applied on the power line L2, i.e., the higher one of output voltage of the battery 12 and output voltage of the alternator 13, is applied on the second connection line L4.

The voltage detection unit 21 is configured as a known voltage detection circuit, for example. The voltage detection unit 21 detects voltage of the second connection line L4 as voltage of the power line L2. A value detected by the voltage detection unit 21 is inputted to the control unit 22. The vehicle information that the acquisition unit 20A acquires includes information that the voltage detection unit 21 can acquire from the second connection line L4 (e.g., battery voltage).

The control unit 22 is configured by an information processing device such as an MCU (Micro Controller Unit), for example. The control unit 22 has a CPU, a ROM, a RAM, and the like, and controls operation of the onboard machine 20. The control unit 22 is connected to the first connection line L3 and can communicate with each electronic control device 11 via the first connection line L3. By transmitting a request signal to the electronic control device 11, the control unit 22 can acquire vehicle information according to the request signal, from the electronic control device 11. The vehicle information that the control unit 22 can acquire by a request signal includes, for example, a vehicle speed, an MIL (Malfunction Indication Lamp) state, an engine rotation speed, and the like.

The communication unit 23 is a communication interface for performing wireless communication with an external device such as the portable terminal 40 by a known wireless communication method. The communication unit 23 has a function of performing wireless communication with the portable terminal 40 in conformity with a wireless communication standard of Bluetooth (registered trademark) communication, for example. Further, the communication unit 23 also has a function as a transmitter that transmits a beacon signal.

The portable terminal 40 is configured as a known portable information processing terminal such as a smartphone or a tablet terminal, for example. The portable terminal 40 includes a control unit 41, a communication unit 44, a display unit 42, an operation unit 46, a storage unit 48, and the like.

The control unit 41 is configured as an information processing device such as an MCU (Micro Controller Unit), for example. The control unit 41 includes a CPU (Central Processing Unit), a ROM, a RAM, and the like, and controls operation of the portable terminal 40. The control unit 41 can perform control in accordance with an application program 48A described later.

The communication unit 44 is a communication device that can perform wired communication and wireless communication by a known communication method. It suffices that the communication unit 44 is configured to be capable of communicating with the onboard machine 20 and capable of communicating with the server 30. In the representative example, the communication unit 44 can perform wireless communication with the communication unit 23 of the onboard machine 20 by Bluetooth (registered trademark) communication. Further, as in the representative example, the communication unit 44 can communicate with the server 30 or another external device by accessing the Internet directly or via an external device by a communication method conforming to a known wireless communication standard such as Wi-Fi (registered trademark), LTE (Long Term Evolution), the fourth-generation mobile communication system, or the fifth-generation mobile communication system.

The display unit 42 is a known display capable of displaying various images such as letters and pictures. The operation unit 46 is an input interface that allows input of information. In the representative example, the display unit 42 and the operation unit 46 form a touch panel.

The storage unit 48 has known storage means such as a semiconductor memory and can store various information. In the storage unit 48, at least the application program 48A is stored. The application program 48A can cause the portable terminal 40 to perform various operations.

The server 30 is a management device having a function of accumulating information and a function of managing information. The server 30 is an information processing device having an information processing function, and is configured by, for example, a computer and the like. The server 30 mainly includes a communication unit 32, a storage unit 36, a control device 38, and the like. The server 30 may be provided with an operation unit having an input device such as a mouse or a keyboard, a display unit having an output device such as a display, and the like.

The control device 38 is configured as, for example, an information processing device having a CPU, ROM, RAM, and the like. The control device 38 has a function of performing various calculations and controls, and a function of controlling operation of the server 30.

The communication unit 32 is a communication device that can perform wireless communication and wired communication by known methods. In the representative example, the communication unit 32 can communicate with the portable terminal 40 or another external device by accessing the Internet directly or via an external device by a communication method conforming to a known wireless communication standard such as Wi-Fi, LTE, the fourth-generation mobile communication system, or the fifth-generation mobile communication system. The communication unit 32 has a function of receiving vehicle information from the portable terminal 40.

The storage unit 36 has a function of accumulating vehicle information received by the communication unit 32. The storage unit 36 includes at least a first database 36A and a second database 36B. The first database 36A is a database for accumulating vehicle information transmitted from the portable terminal 40. The second database 36B is a database for storing delivery information to be transmitted to the portable terminal 40.

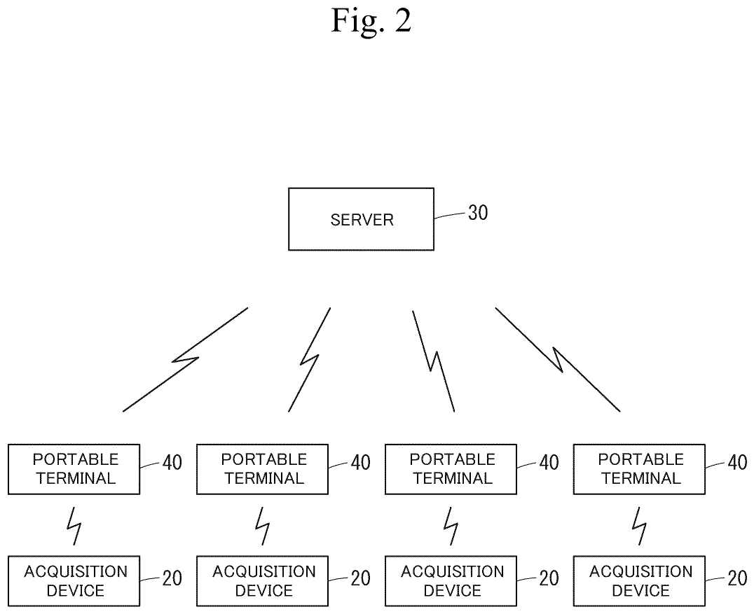

In the example shown in FIG. 1, one onboard machine 20 and the portable terminal 40 associated with this onboard machine 20 are shown and the server 30 collects information from the portable terminal 40. However, the server 30 can also communicate with other portable terminals 40 as shown in FIG. 2, as in communication with the portable terminal 40 as shown in FIG. 1. In the example shown in FIG. 2, in a case where vehicle information is transmitted from each portable terminal 40 to the server 30, vehicle information is transmitted in association with identification information (ID) assigned to each portable terminal 40. For example, in a case where identification information of the portable terminal 40 shown in FIG. 1 is ID1, when vehicle information is transmitted from this portable terminal 40 to the server 30, the vehicle information and ID1 associated with each other are transmitted to the server 30.

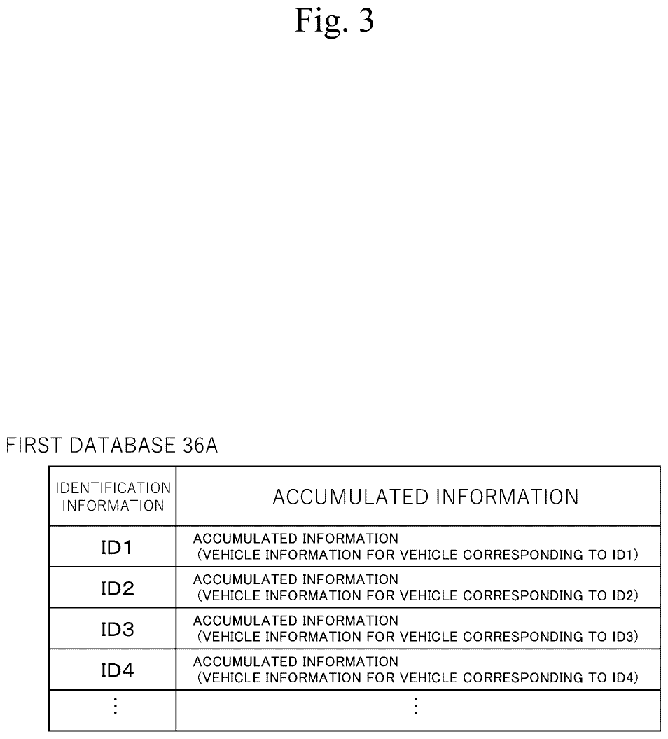

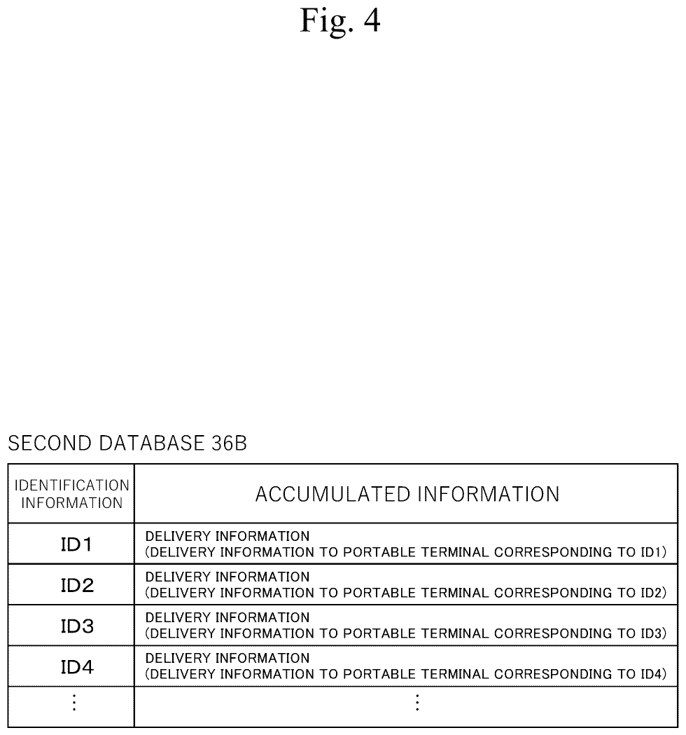

As shown in FIG. 3, in the first database 36A provided in the server 30, vehicle information is accumulated in a state where vehicle information for each identification information (each ID) can be specified. Therefore, in a case of reading vehicle information from the first database 36A, if any identification information (ID) is designated, the vehicle information accumulated in the first database 36A in association with the designated identification information (ID) can be read. As shown in FIG. 4, in the second database 36B, delivery information for each identification information (each ID) is accumulated.

### 1-2. Operation of Vehicle Information Management System 100

The following description relates to operation of the vehicle information management system 100.

Hereinafter, an example in which specific identification information (ID1) is assigned to the portable terminal 40 and the application program 48A shown in FIG. 1, and delivery information is delivered from the server 30 to the portable terminal 40 and the application program 48A, will be described.

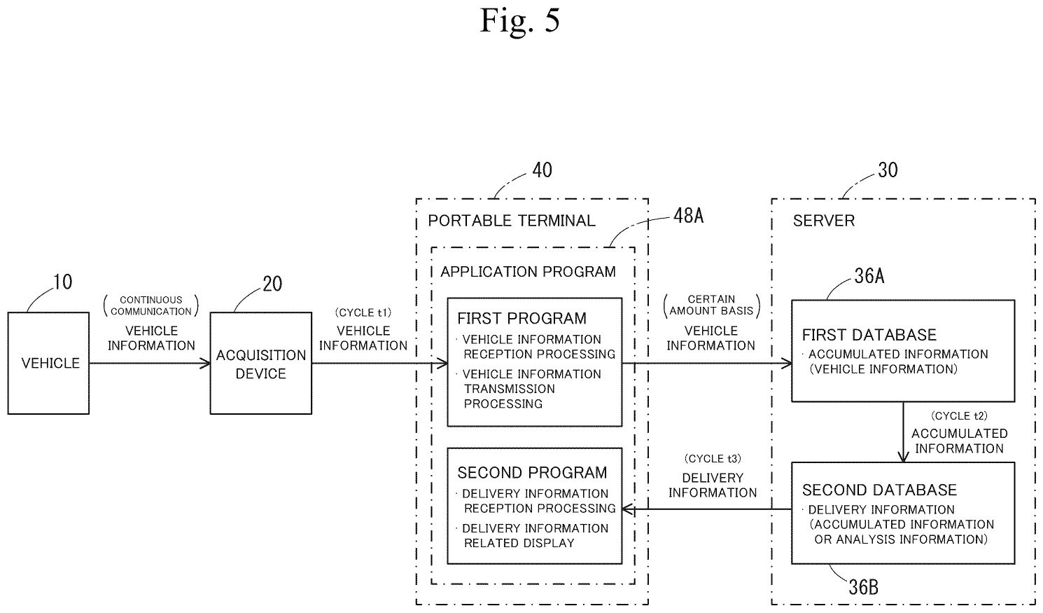

The onboard machine 20 can continuously perform wireless communication with the portable terminal 40 in a state where the onboard machine 20 is mounted in the vehicle 10 and connected to the connector 15 as shown in FIG. 1. In the representative example described below, in a state where the onboard machine 20 is mounted in the vehicle 10 and connected to the connector 15, the onboard machine 20 keeps a state of being paired with the portable terminal 40 and continuously performs Bluetooth (registered trademark) communication with the portable terminal 40. Then, while keeping a state where the onboard machine 20 can communicate with both of the vehicle 10 and the portable terminal 40, the onboard machine 20 continuously acquires the above-described vehicle information from the vehicle 10, and transmits the acquired vehicle information to the portable terminal 40 at every first cycle t1 (e.g., 10 minutes) (see FIG. 5). In a case where the onboard machine 20 acquires vehicle information from the vehicle 10, the vehicle information may be acquired intermittently at time intervals shorter than the first cycle t1, or may be acquired continuously.

In the portable terminal 40 shown in FIG. 1, when a predetermined start condition is satisfied, the application program 48A is executed by the control unit 41. The predetermined start condition may be that Bluetooth (registered trademark) communication is started between the onboard machine 20 and the portable terminal 40, or may be that a predetermined operation is performed on the portable terminal 40, or may be another condition. In a case where the application program 48A is executed by the control unit 41, the application program 48A may be executed in the foreground or in the background.

In a state where the application program 48A is executed, when vehicle information is transmitted from the communication unit 23 (transmission unit) to the portable terminal 40 and the communication unit 44 has received the vehicle information transmitted by the communication unit 23, the application program 48A causes the portable terminal 40 to perform an operation of transmitting the received vehicle information to the server 30. Specifically, in a case where the communication unit 44 has received the vehicle information transmitted from the onboard machine 20, the application program 48A causes the control unit 41 to store the vehicle information in the storage unit 48. Further, in a case where, regarding the vehicle information received from the onboard machine 20, “un-transmitted vehicle information that has not yet been transmitted to the server 30” has reached a certain amount (predetermined number of pieces), the application program 48A operates so as to transmit the un-transmitted vehicle information to the server 30 (see FIG. 5).

In the representative example, the application program 48A divides vehicle information for each predetermined period X (e.g., 7 seconds) and treats the information for each predetermined period X regarding the vehicle information, as one piece of information. Then, in a case where the number of pieces of vehicle information that have not yet been transmitted to the server 30 exceeds 10, the application program 48A immediately transmits, to the server 30, all pieces of un-transmitted vehicle information that have not yet been transmitted to the server 30 and have been stored in the portable terminal 40. For example, in a case where the first cycle t1 is 10 minutes and the onboard machine 20 transmits vehicle information to the portable terminal 40 every 10 minutes, the onboard machine 20 continuously acquires vehicle information for 10 minutes from the vehicle 10, and transmits the vehicle information acquired for the latest 10 minutes, at a timing when 10 minutes have elapsed since the last transmission timing. Therefore, the portable terminal 40 acquires the vehicle information for such 10 minutes, from the onboard machine 20. In this case, in the portable terminal 40 just after acquiring the vehicle information for 10 minutes from the onboard machine 20, pieces of vehicle information that have not yet been transmitted to the server 30 are present at least in an amount corresponding to 10 minutes (86 pieces). Thus, the application program 48A determines that the number of pieces of vehicle information that have not yet been transmitted to the server 30 has exceeded 10, and transmits all the pieces of vehicle information for the latest 10 minutes acquired from the onboard machine 20, to the server 30.

In this way, every time the onboard machine 20 transmits vehicle information to the portable terminal 40 at each first cycle t1 (e.g., 10 minutes), the application program 48A immediately operates the portable terminal 40 so as to transmit the vehicle information to the server 30. That is, the application program 48A causes the portable terminal 40 to perform a basic operation of transmitting vehicle information to the server 30 regularly (specifically, regularly at every first cycle t1 (e.g., 10 minutes). In a case where the application program 48A shown in FIG. 1 transmits vehicle information to the server 30, the vehicle information is transmitted in association with the identification information (ID1) uniquely assigned to the portable terminal 40 having the application program 48A.

The server 30 shown in FIG. 1 receives vehicle information transmitted from the portable terminal 40, by the communication unit 32, and accumulates the vehicle information received by the communication unit 32, in the storage unit 36 (accumulation unit). For example, in a case where the communication unit 32 has received the vehicle information associated with the identification information ID1, the control device 38 performs first control so as to accumulate the vehicle information in the first database 36A as accumulated information corresponding to the identification information ID1.

The control device 38 performs second control so as to transfer the accumulated information accumulated in the first database 36A from the first database 36A to the second database 36B regularly at a second cycle t2 (see FIG. 5). In a case of transferring the accumulated information from the first database 36A to the second database 36B, the accumulated information may be transferred in a copied manner (so as to remain in the first database 36A) or may be transferred without remaining in the first database 36A. For example, in a case of transferring the accumulated information corresponding to ID1 from the first database 36A to the second database 36B, the control device 38 performs the second control so that, among the accumulated information corresponding to ID1 in the first database 36A, accumulated information that has not been transferred to the second database 36B is collectively transferred to the second database 36B at every second cycle t2. The accumulated information transferred from the first database 36A to the second database 36B is, directly or after undergoing analysis processing or the like, stored as delivery information in the second database 36B as shown in FIG. 4.

In the second database 36B, the accumulated information accumulated in the first database 36A itself may be stored, or analysis information obtained through analysis on the accumulated information may be stored instead of the accumulated information or in addition to the accumulated information. For example, in a case where the control device 38 performs the second control so as to transfer the accumulated information corresponding to ID1 from the first database 36A to the second database 36B, as delivery information corresponding to ID1, individual values of vehicle information (such as vehicle speed, MIL state, engine rotation speed, and battery voltage) of the vehicle 10 (FIG. 1) corresponding to ID1, and in addition, statistical values of the above vehicle information (e.g., a mean value, a maximum value, a minimum value, a cumulative value, and a latest value during a latest predetermined period) as analysis information, may be regularly accumulated. Analysis information obtained through analysis on vehicle information is not limited to the above example, and may include a cumulative traveling distance or an elapsed period from the last maintenance timing, a cumulative traveling distance or an elapsed period from the last oil change timing, a cumulative traveling distance or an elapsed period from the last tire change timing, or the like. Alternatively, an optimum oil change timing and an optimum tire change timing may be calculated using the above vehicle information, and these timings may be used as pieces of analysis information. Further, maintenance suggestion information for suggesting a part that requires maintenance or change in the vehicle 10 may be calculated using the above vehicle information, and such maintenance suggestion information may be used as a piece of analysis information.

In the server 30, the control device 38 and the communication unit 32 function as a delivery unit, and deliver delivery information including at least either the above-described accumulated information or the analysis information obtained through analysis on the accumulated information, to the portable terminal 40, regularly at a third cycle t3. The control device 38 and the communication unit 32 can regularly deliver the delivery information to the portable terminal 40, on the basis of information accumulated in the second database 36B. In a case where accumulated information (vehicle information) is accumulated in the second database 36B, the accumulated information can be delivered, and in a case where accumulated information and analysis information are accumulated in the second database 36B, either or both of the accumulated information and the analysis information can be delivered.

When the communication unit 44 has received the delivery information delivered from the server 30, the application program 48A operates so as to cause the display unit 42 to perform display based on the delivery information received by the communication unit 44. This operation may be automatically performed when the application program 48A is being executed, or may be performed when a predetermined operation is performed on the portable terminal 40. In a case where the delivery information received by the communication unit 44 includes individual values of vehicle information (such as vehicle speed, MIL state, engine rotation speed, and battery voltage) and/or statistical values thereof (e.g., a mean value, a maximum value, a minimum value, a cumulative value, and a latest value during a latest predetermined period), the application program 48A may cause the display unit 42 to display these values or graphs thereof. In a case where the delivery information received by the communication unit 44 includes a cumulative traveling distance or an elapsed period from the last maintenance timing, a cumulative traveling distance or an elapsed period from the last oil change timing, a cumulative traveling distance or an elapsed period from the last tire change timing, an optimum oil change timing, an optimum tire change timing, maintenance suggestion information, or the like, the application program 48A may cause the display unit 42 to display the above information by letters, pictures, or the like.

### 1-3. Coordinating Operation

The following description relates to operation of coordinating the onboard machine 20 and the portable terminal 40 with each other. In a case where a predetermined condition is satisfied, the control unit 22 and the communication unit 23 provided in the onboard machine 20 start coordinating operation. The “case where the predetermined condition is satisfied” may be, for example, a case where the vehicle 10 is started (a case where a starting switch (ignition switch or the like) is switched from OFF to ON), or may be a case where communication between the vehicle 10 and the onboard machine 20 is started, or a case where another start condition is satisfied.

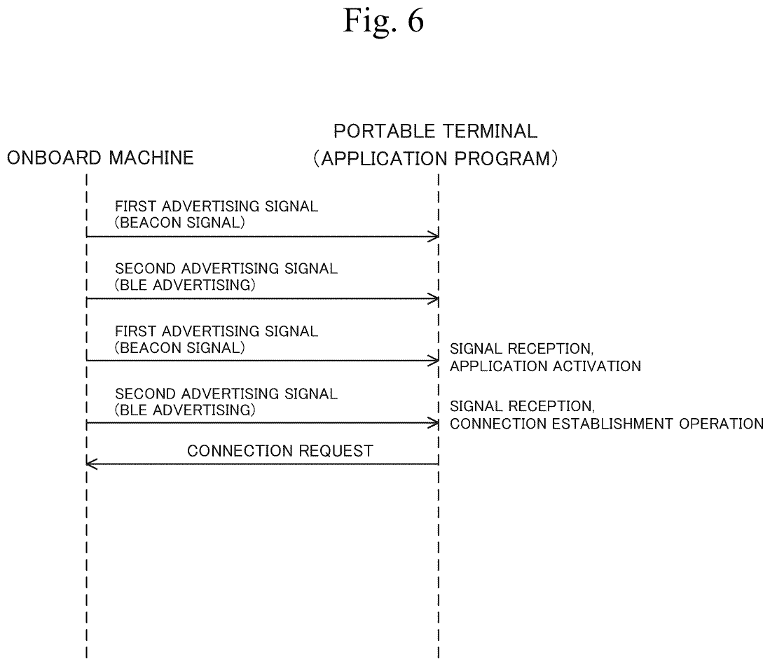

In the present embodiment, the control unit 22 and the communication unit 23 correspond to an example of a wireless communication device. When having started coordinating operation, the wireless communication device (control unit 22 and communication unit 23) performs communication operation so as to alternately repeat one or more times of a first operation of wirelessly transmitting first advertising information in a predetermined format including identification information, as a beacon signal, and one or more times of a second operation of wirelessly transmitting second advertising information by a near field communication method. In the representative example described below, as shown in FIG. 6, communication operation is performed such that one time of the first operation (specifically, one time of beacon signal transmission operation) and one time of the second operation (specifically, one time of BLE advertising transmission operation) are alternately switched at predetermined period (e.g., 5 seconds) intervals.

The beacon signal transmitted by the wireless communication device (control unit 22 and communication unit 23) is a signal conforming to a standard of iBeacon (registered trademark), and the predetermined format is a format of iBeacon (registered trademark). The onboard machine 20 transmits an advertising packet conforming to the format of iBeacon (registered trademark), as the first advertising information, in order to perform notification about the presence of the onboard machine 20 at certain time intervals. The advertising packet includes UUID, a Major value, a Minor value, a TxPower value, and the like as identification information for identifying the individual machine, and these conform to a standard format of Bluetooth (registered trademark) Low Energy. The beacon signal transmitted from the onboard machine 20 includes the identification information uniquely assigned.

The application program 48A provided in the portable terminal 40 is set so as to be activated when a beacon signal in a predetermined format (format of iBeacon (registered trademark)) including specific identification information is received. Therefore, even when the application program 48A is in an ended state in the portable terminal 40, if the portable terminal 40 has received any of beacon signals repeatedly transmitted from the wireless communication device (control unit 22 and communication unit 23), the application program 48A starts operating, so that operation as described in “1-2. Operation of vehicle information management system 100” can be performed.

The wireless communication device (control unit 22 and communication unit 23) wirelessly transmits an advertising packet (second advertising information) conforming to the standard of BLE, by a BLE method, after elapse of a certain period from transmission of the beacon signal. The advertising packet (second advertising information) includes an identifier uniquely assigned in the onboard machine 20.

After operation is started, when it is confirmed that the portable terminal 40 has received the advertising packet (second advertising information), the application program 48A operates the portable terminal 40 so as to transmit a connection request to the transmission source (onboard machine 20) of the above advertising packet (second advertising information), to attempt connection by a BLE method with the onboard machine 20. When having received the connection request transmitted from the portable terminal 40, the onboard machine 20 responds to the connection request and establishes connection with the portable terminal 40.

### 1-4. Example of Effect of First Embodiment

In a case where the portable terminal 40 having the application program 48A is present in an area where the beacon signal reaches, the onboard machine 20 can forcibly activate the application program 48A by the beacon signal even when the application program 48A is in an ended state. Then, after the beacon signal, the onboard machine 20 can provide the second advertising information to the portable terminal 40, and therefore can establish connection for near field communication (BLE communication) between the portable terminal 40 and the onboard machine 20. Further, even if the portable terminal 40 cannot receive the beacon signal, thereafter beacon signals are repeated. Therefore, as long as the portable terminal 40 is present in an area where the beacon signal reaches, any of the beacon signals is likely to be successfully received on the portable terminal 40 side, and in addition, since the second advertising information is transmitted after each beacon signal, connection for near field communication is easily established immediately after the beacon signal is successfully received (i.e., after activation of the application program).

### Other Embodiments

The present invention is not limited to the embodiment described above with reference to the drawings, and for example, embodiments as shown below are also included in the technical scope of the present invention. In addition, various features of the above embodiment and embodiments described below may be combined in any manner without contradicting each other.

In the above embodiment, the vehicle 10 is a gasoline engine vehicle using gasoline as fuel. However, the vehicle 10 may be an engine vehicle using fuel other than gasoline or may not be an engine vehicle. For example, the vehicle 10 may be an engine vehicle using hydrogen, liquefied petroleum gas, or the like as fuel, a hybrid vehicle, or an electric vehicle.

In the above embodiment, in the onboard machine 20, the first operation and the second operation are alternately repeated one time for each, but the present invention is not limited thereto. In the alternate repetition, either or both of the first operation and the second operation may be performed a plurality of times for each. For example, two times of the first operation and two times of the second operation may be repeated alternately.

In the above embodiment, the beacon signal is a signal conforming to the standard of iBeacon (registered trademark). However, a beacon signal conforming to another standard may be adopted as long as the beacon signal serves as a trigger for activating the application program. The near field communication method may be other than the BLE method as long as the near field communication method can be executed when the application program is in an activated state.

It should be understood that the embodiments disclosed herein are illustrative in all aspects and thus are not restrictive. The scope of the present invention is not limited to the embodiments disclosed herein, and is intended to include all modifications within a scope defined in the claims or a scope equivalent to the claims.

### DESCRIPTION OF REFERENCE NUMERALS

10: vehicle
20: onboard machine
20A: acquisition unit
22: control unit (wireless communication device)
23: communication unit (wireless communication device)
40: portable terminal
48A: application program
100: vehicle information management system

What is claimed is:

1. An onboard machine comprising:
an acquisition unit configured to acquire vehicle information indicating a state of a vehicle, from the vehicle; and
a wireless communication device configured to wirelessly transmit the vehicle information acquired by the acquisition unit, to a portable terminal, by a near field communication method, wherein
the portable terminal includes an application program configured to be activated on the portable terminal when the portable terminal has received a beacon signal in a predetermined format including predetermined identification information, and cause the portable terminal to perform an operation of establishing connection by the near field communication method, after activation, and
the wireless communication device alternately repeats one or more times of a first operation of wirelessly transmitting first advertising information in the predetermined format including the identification information, as the beacon signal, and one or more times of a second operation of wirelessly transmitting second advertising information by the near field communication method.

2. The onboard machine according to claim 1, wherein
the beacon signal is a signal conforming to a standard of iBeacon (registered trademark), and
the near field communication method is a BLE (Bluetooth (registered trademark) Low Energy) method.

3. A vehicle information management system comprising:
the onboard machine according to claim 1; and
the application program.
